(19) United States
(12) Patent Application Publication
(10) Pub. No.: US 2007/0053370 A1
(43) Pub. Date: Mar. 8, 2007

(54) Method of providing access to packet-switched services in a heterogeneous network environment

(75) Inventors: Abdol Hamid Aghvami, London (GB); Paul Anthony Pangalos, London (GB); Daniel Morris, Otley (GB)

Correspondence Address: KELLEY DRYE & WARREN LLP, TWO STAMFORD PLAZA, 281 TRESSER BOULEVARD, STAMFORD, CT, 06901, US

(73) Assignee: King's College London, London (GB)

(21) Appl. No.: 11/515,990

(22) Filed: Sep. 5, 2006

(30) Foreign Application Priority Data
Sep. 6, 2005 (GB) 0518107.8

(51) Int. Cl. H04L 12/56

(52) U.S. Cl. 370/401

(57) ABSTRACT

A method of providing access for a multi-mode mobile terminal (13) to packet-switched services in a heterogeneous network environment (10) comprising a uni-directional network (12) and a bi-directional network (11), which method comprises the step of creating and storing a data structure in each of said multi-mode mobile terminal (13), said bi-directional network (11) and said uni-directional network (12), storing of said data structures activating a logical association between said multi-mode mobile terminal (13) and said uni-directional network (11) via said bi-directional network (12), which logical association facilitates inter-working of said uni-directional and bi-directional networks for delivering datagrams to said multi-mode mobile terminal (13) from said uni-directional network (12).

### CROSS-REFERENCE TO RELATED APPLICATIONS

This application claims priority from application number GB 0518107.8, filed Sep. 6, 2005. The disclosure of each such application is hereby incorporated by reference in its entirety where appropriate for teachings of additional or alternative details, features, and/or technical background, and priority is asserted from each.

### FIELD OF THE INVENTION

The present invention relates to a method of providing access for a multi-mode mobile terminal to packet-switched services in a heterogeneous network environment, to a method of configuring a multi-mode mobile terminal for receiving packet-switched services, to a method of establishing a logical association between a bi-directional network and a uni-directional network, to a multi-mode terminal, to a network node, to a computer program and to a computer program product.

### BACKGROUND TO THE INVENTION

The packet-switched domain of a radio communication network provides access for mobile terminals to external packet data networks such as the Internet. Current (and particularly future) radio communication environments comprise a number of different access technologies and different administrative domains in which the cellular coverage of one network overlays the cellular coverage of another; such an environment is herein referred to as a heterogeneous network environment. Mobile terminals, such as mobile phones, PDAs, handheld gaming devices and notebook computers, are being provided with the ability to connect to a number of different radio access networks to take advantage of the heterogeneous network environment such as by choosing the best network to use at that time. For example, a mobile terminal may be provided with a DVB interface for receiving digital broadcast data, and a UMTS interface for making telephone calls and accessing the Internet. This functionality may be provided by a single re-configurable interface (e.g. with Software Defined Radio) or by physically separate interfaces. Such mobile terminals are referred to herein as multi-mode mobile terminals.

Each multi-mode mobile terminal (MMT) has a home network by which is meant that network where the terminal has a permanent network layer address such as an IP address. Usually the home network is also responsible for storing user profiles, and for billing the user for access to the home network and any foreign network that the multi-mode mobile terminal uses.

Digital broadcast networks (such as American Television Standards Committee (ATSC), European Telecommunications Standards Institute Digital Video Broadcasting (DVB) and Japanese Integrated Service Digital Broadcasting (ISDB)) are generally intended to offer point-to-multipoint unidirectional data transfer, although some schemes have been proposed for limited capacity data transfer from mobile terminals back to the broadcast network (for example DVB-Return Channel Terrestrial and Return Channel Satellite). Currently data is transmitted from a number of transmitters to provide coverage for a certain large geographical area (˜80 km radius). Digital broadcast networks are characterised by high data transfer rates on the downlink. For example a DVB network may broadcast multiplexed data transmission streams at a rate of the order of tens of Mbps. In contrast, mobile cellular networks offer a point-to-point bi-directional voice and limited data service between terminals (either mobile of fixed). Data transfer rates in mobile cellular networks are generally lower than digital broadcast networks. For example IMT-2000 (e.g. UMTS) networks will offer a bandwidth of approximately 2 Mbps.

Attention has recently been turned to use of such digital audio and video broadcast networks for transmission of datagrams. For example it has been proposed that the DVB-Handheld (DVB-H) standard in conjunction with IP Datacast (IPDC) can be used to deliver datagrams to mobile terminals. The present DVB-H specification (EN 302 304) is available at www.etsi.org. IPDC is an end-to-end broadcast system for delivery of any type of digital content and services using IP-based mechanisms. An inherent part of the IPDC system is a uni-directional DVB broadcast path and a bi-directional mobile/cellular interactivity path. IPDC is thus a platform for convergence of services from mobile/cellular and broadcast/media domains. Further information on IPDC can be found at www.dvb.org (see for example “IPDC in DVB-H: Technical Requirements” CBMS1026 v1.0.0 Rev.1/TM 3095 Rev. 2).

With increasing popularity of multi-mode mobile terminals, it will be important that the different network providers co-operate to provide a seamless service from the perspective of the user. Accordingly it is envisaged that different networks in the heterogeneous network environment should inter-work to this end, and this is subject of on-going research and development. For example, it is envisaged that whilst cellular network may receive requests from multi-mode mobile terminals for a particular service and/or content (e.g. multi-media, file sharing, online gaming), the larger downlink bandwidth of digital broadcast networks can be utilised to deliver those services and/or that content.

However, the service provider sending datagrams over a broadcast network cannot determine if the user has received them until, for example, the user complains that he paid for a service but did not receive it. In particular a datagram encapsulator in the broadcast network encapsulates datagrams into an MPEG Transmission Stream. As the broadcast network is uni-directional no provision is made for reliable data delivery at the MPEG transport layer. Furthermore as many of the multimedia services use technology such as multicast and streaming over UDP, there is no inherent provision for reliable data delivery between the sending host and each multi-mode mobile terminal. Even using TCP/IP in unicast datagram delivery over the broadcast network, the receiver would need to be specially adapted to send TCP acknowledgements using the uplink of the cellular network. Bearing in mind the limited bandwidth available in a cellular uplink, this may not be desirable.

To compound this problem the broadcast interface on a multi-mode mobile terminal often requires manual configuration by the user in order to receive datagrams. Configuration data such as the correct frequency, symbol rate, network ID and Program Identifier (PID) must be input by the user to configure the interface. Very often insufficient data is input and/or it is input incorrectly.

Furthermore the user is likely to roam in the heterogeneous network environment and have access to different broadcast networks at different times. It will therefore be necessary for the multi-mode terminal to be re-configured dynamically to receive data once a broadcast network is selected. Accordingly, it is desirable if there were some way to configure an interface on a multi-mode mobile terminal before service/content delivery commences and to maintain the interface correctly configured as the multi-mode mobile terminal roams in the heterogeneous network environment so that it can receive datagrams from different broadcast networks.

WO 2005/041594 discloses a method for selection of a service in a heterogeneous network environment. Via the internet or a mobile telephone network a user of a mobile telephone is able to visit a WAP portal to select a service to be delivered by IPDC over a broadcast network. The WAP portal responds to the mobile telephone with channel parameter data that includes the name of the service, the IP address, port number, Network Information Table (NIT), IP/MAC Notification Table (INT) and Program Mapping Table (PMT). The last three items may be delivered via the broadcast network. The broadcast network is only able to deliver broadcast services to the mobile telephone (i.e. those services to be received by all mobile telephones); therefore the mobile telephone is not “visible” to the broadcast network. The aforementioned IP/MAC mapping problem is not addressed and the broadcast network is not able to deliver content using multicast or unicast transmission protocols for example which is a major drawback.

### SUMMARY OF THE INVENTION

According the present invention there is provided a method of providing access for a multi-mode mobile terminal to packet-switched services in a heterogeneous network environment comprising a uni-directional network and a bi-directional network, which method comprises the step of storing a data structure in each of said multi-mode mobile terminal, said bi-directional network and said unidirectional network, storing of said data structures activating a logical association between said multi-mode mobile terminal and said uni-directional network via said bi-directional network, which logical association facilitates inter-working of said uni-directional and bi-directional networks for delivering datagrams to said multi-mode mobile terminal from said uni-directional network. Further data structures may be created and stored for the same multi-mode mobile terminal to provide more than one logical association. The logical association may provide a virtual connection between the multi-mode mobile terminal and the uni-directional network. One advantage of this is that changes in a network layer address of the multi-mode mobile terminal (e.g. due to establishment of a further data structures and/or re-establishment of the first data structure) can be automatically signalled to the unidirectional network.

Preferably, the method further comprises the step of using said data structure to facilitate routing of datagrams between said bi-directional network and said uni-directional network. The logical association may also provide for QoS, billing, etc.

Advantageously, the method further comprises the step of using said logical association to transfer a configuration parameter from said uni-directional network to said multi-mode mobile terminal via said bi-directional network. This helps the process of configuring the uni-directional interface of the MMT to be automated so that it does not need to be reliant on user input. Furthermore this can relieve the MMT from processing control channels in the uni-directional network that carry network information such as service configuration parameters (e.g. PID), INT tables, PMT tables, etc. This is very important for hand-held portable terminals where battery life is limited. The configuration parameter may comprise a plurality of configuration parameters for facilitating configuration of the uni-directional interface.

Preferably, said configuration parameter comprises a service configuration parameter mapping link layer packets to be transmitted by said uni-directional network, to a network layer address to which a service is addressed, receipt of said service configuration parameter enabling said multi-mode mobile terminal to extract and read the link layer packets comprising said service.

In one embodiment said service configuration parameter comprises a Packet Identifier (PID) and said link layer packets comprise MPEG Transport Stream Packets.

Advantageously, wherein said configuration parameter comprises a network interface configuration parameter for configuring an interface of said multi-mode terminal to receive datagrams from said uni-directional network. The configuration parameter may comprise frequency, network ID and symbol rate of the uni-directional network for example.

Preferably, the method further comprise the step of said multi-mode mobile terminal receiving said configuration parameter and configuring an interface therewith.

Advantageously, said configuring step is performed automatically by said multi-mode mobile terminal when said configuration parameter is received. In this way no user input is required.

Preferably, the method further comprises the step of said multi-mode mobile terminal requesting a one-to-many type service, wherein said logical association is established in response to said request.

In one embodiment said one-to-many type service is to be delivered by one of a multicast and a broadcast transmission protocol.

Advantageously, the method further comprises the step of said multi-mode mobile terminal transmitting toward said uni-directional network a link-layer address by which it is reachable, receipt of said link-layer address enabling said unidirectional network to map a network layer address of said multi-mode mobile terminal to said link-layer address, whereby datagrams arriving at said uni-directional network addressed to said network layer address may be encapsulated in link-layer packets addressed to said link-layer address by means of said mapping. In this way the uni-directional network may discover the MAC address of the broadcast interface of the MMT for example, without the need for a user to advise. Furthermore any changes in MAC address can be sent automatically by the MMT to the uni-directional network.

Preferably the method further comprises the step of said bi-directional network receiving said link-layer address and storing it as part of said data structure.

Advantageously, the method further comprises the step of said bi-directional network forwarding said link-layer address toward said uni-directional network.

Preferably, the method further comprises the step of configuring a network layer address for said multi-mode mobile terminal, and forwarding said network layer address toward said uni-directional network. The network layer address may be an IPv4 or IPv6 address for example. The configuring step may comprise the step of sending a request to a DHCP server, or advertising a network prefix to the MMT to enable the MMT to auto-configure an IPv6 address for example.

Advantageously, said network layer address is transmitted with said link-layer address to facilitate said mapping.

Preferably, the method further comprises the step of said uni-directional network receiving said link-layer address and storing as part of said data structure.

Advantageously, the method further comprises the step of mapping said link-layer address to said network layer address and storing as part of said data structure in said uni-directional network. In this way the uni-directional network can perform an IP-MAC mapping without requiring user input.

Preferably, storing of said data structure triggers said uni-directional network to transmit a configuration parameter toward said multi-mode mobile via said bi-directional network, said configuration parameter for facilitating configuration of said multi-mode mobile terminal to receive datagrams from said uni-directional network.

Advantageously, the method further comprises the step of said multi-mode mobile terminal requesting a one-to-one type service, wherein said logical association is established in response to said request.

In one embodiment said one-to-one type service is to be delivered by a unicast transmission protocol.

Preferably, the method further comprises the steps of said multi-mode mobile terminal transmitting a uni-directional Access Point Name (APN) toward said bi-directional network, said bi-directional network using said uni-directional APN to lookup an address representing a network node on said uni-directional network with which said logical association is to be established. The APN may be representative of an inter-networking service such as live Multimedia on Demand for example.

Advantageously, the method further comprises the steps of using location data representing a current or recent physical location of said multi-mode mobile terminal to query a network domain database comprising a mapping between location data and communication addresses, said network domain database returning a list comprising a communication address for the or each available data communication network, each of which provides coverage at said physical location, whereby said bi-directional network may contact the or each available data communication network. The location data may comprise a location area of said multi-mode mobile terminal. The communication address may be any network layer address e.g. an IP address, a URI or a SIP address.

In one embodiment, the method further comprises the steps of listening to determine a network identity of each data communication network having a downlink channel that can be received by said multi-mode mobile terminal, and transmitting said location data comprising the or each network identity to said bi-directional data communication network.

In another embodiment, the method further comprises the step of for each available data communication network determining a cell identity of a cell in which said multi-mode terminal presently resides, and transmitting said location data comprising the or each cell identity to said second data communication network.

Advantageously, said data structure comprises a field storing a link-layer address of said multi-mode mobile terminal.

Preferably, said data structure comprises an extended PDP context, the method further comprising the step of said multi-mode mobile terminal sending an activate PDP context request comprising an extended PDP information element comprising a link-layer address of a uni-directional interface of said multi-mode terminal. One benefit of this is that existing signalling mechanisms in the bi-directional network can be used to support the extended functionality; an entity in the uni-directional network may be provided with analogous functionality to an entity in the bi-directional network. In another embodiment the data structure comprises an extended MBMS UE Context. The PDP or MBMS information element may also comprise fields containing uplink and downlink APNs.

Advantageously, a network node on said bi-directional network performs the steps of receiving said activate PDP context request, storing said an extended PDP context on said network node, and sending a create PDP context request to said uni-directional network, said create PDP context request comprising said extended PDP information element. This step may be repeated on the bi-directional network, for example at a SGSN and GGSN in a UMTS network.

Preferably, a network node on said uni-directional network performs the steps of receiving said create PDP context request, storing said an extended PDP context on said network node, and sending an activate PDP context response to said bi-directional network, said activate PDP context response comprising a service configuration parameter and a network interface configuration parameter.

According to another aspect of the present invention there is provided a method of configuring a multi-mode mobile terminal for receiving packet-switched services at from a unidirectional network, which method comprises the steps of:

(a) sending from said multi-mode mobile terminal to a bi-directional network a request for access to a packet-switched data service;

(b) awaiting from said bi-directional network a service configuration parameter and a network interface configuration parameter for said uni-directional network;

(c) using said network interface configuration parameter to configure an interface on said multi-mode mobile terminal to receive data from said uni-directional network; and

(d) using said service configuration parameter to filter a channel comprising said packet-switched service from data transmitted from said uni-directional network.

According to another aspect of the present invention there is provided a method of establishing a logical association between a bi-directional network and a uni-directional network, which method comprises the steps of:

(a) receiving on said bi-directional network a request from a multi-mode mobile terminal for access to a packet-switched data service;

(b) storing a data structure in a memory of a network node on said bi-directional network;

(c) and transmitting a request to a network node on said unidirectional network as part of establishment of said logical association.

According to another aspect of the present invention there is provided a method of establishing a logical association between a bi-directional network and a uni-directional network, which method comprises the steps of:

(a) receiving on said uni-directional network a request from a network node on said bi-directional network for access to a packet-switched data service;

(b) storing a data structure in a memory of a network node on said uni-directional network; and

(c) transmitting a reply to the network node on said bi-directional network as part of establishment of said logical association.

According to yet another aspect of the present invention there is provided a multi-mode mobile terminal comprising a memory storing computer executable instructions for performing the multi-mode mobile terminal method steps as set out above.

According to another aspect of the present invention there is provided a computer program comprising computer executable instructions for causing a multi-mode mobile terminal to perform the multi-mode mobile terminal method steps as set out above.

According to another aspect of the present invention there is provided a network node for use in a bi-directional network, which network node comprises comprising a memory storing computer executable instructions for performing the bi-directional network method steps as set out above.

In one embodiment the network node comprises a GGSN and/or a SGSN and/or BM-SC.

According to another aspect of the present invention there is provided a computer program comprising computer executable instructions for causing a network node in a bi-directional network to perform the bi-directional network method steps as set out above.

According to another aspect of the present invention there is provided a network node for use in a unidirectional network, which network node comprises comprising a memory storing computer executable instructions for performing the uni-directional network method steps as set out above.

In one embodiment the network node comprises a gateway to said uni-directional network.

According to another aspect of the present invention there is provided a computer program comprising computer executable instructions for causing a network node in a unidirectional network to perform the uni-directional network method steps as set out above.

According to another aspect of the present invention there is provided a computer program product storing computer executable instructions as set out above.

Advantageously, the computer program product is embodied on a record medium, in a computer memory, in read-only memory or on an electrical carrier signal.

### BRIEF DESCRIPTION OF THE FIGURES

For a better understanding of how the present invention may be put into practice, a preferred embodiment of the invention applied in a hetereogeneous network environment comprising a bi-directional network and a uni-directional network will be described, by way of example only, with reference to the accompanying drawings in which:

FIG. 1 is a schematic block diagram of a heterogeneous network environment comprising a bi-directional network and a uni-directional network having a logical interface therebetween;

FIG. 2 is a block diagram of the bi-directional network and uni-directional network architecture of FIG. 1;

FIG. 3 is a signalling diagram of a first embodiment of a method according to the present invention;

FIG. 4 is a signalling diagram of a second embodiment of a method according to the present invention;

FIG. 5 is a schematic block diagram of a mobile terminal in accordance with the present invention; and

FIG. 6 is a schematic block diagram of a network node in accordance with the present invention.

### DETAILED DESCRIPTION OF THE PREFERRED EMBODIMENTS

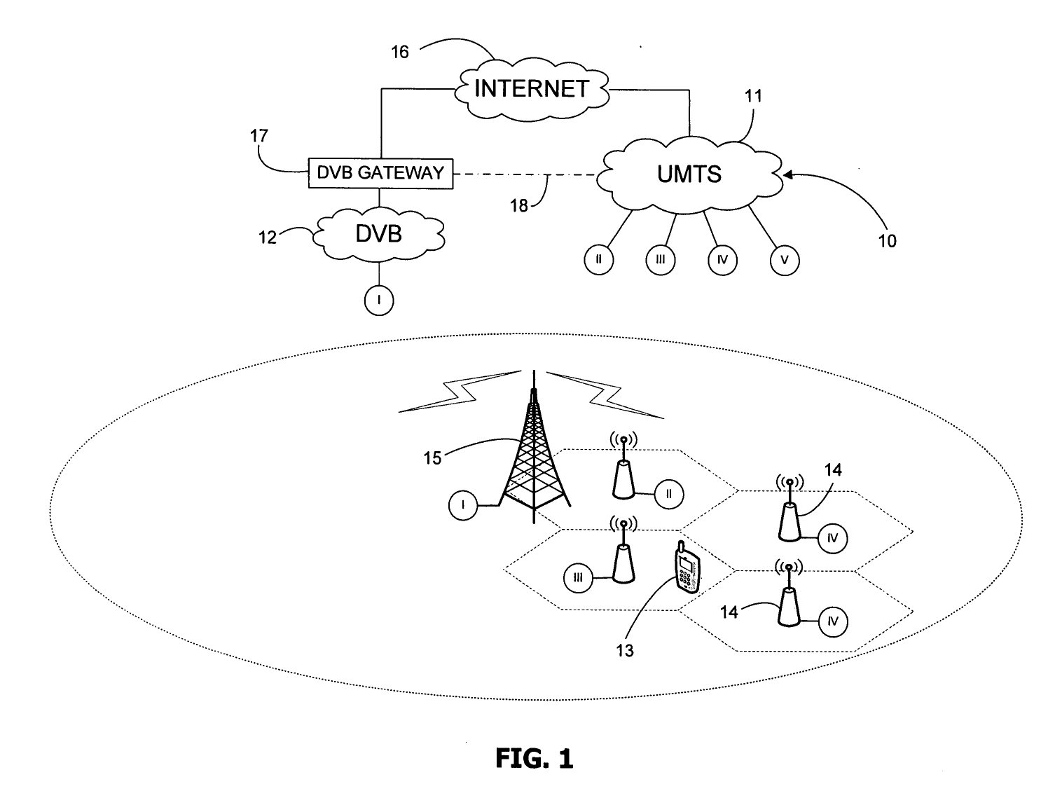

Referring to FIG. 1 a heterogeneous network generally identified by reference numeral 10 comprises a bi-directional network which in this case is a cellular network 11 (e.g. UMTS) and a uni-directional network which in this case is a broadcast network 12 (e.g. DVB). Each of the two networks 11, 12 is under a different administrative domain and they are heterogeneous i.e. the protocols for access, transmission and handling of data may differ between the networks. A Multi-mode Mobile Terminal (MMT) 13 has interfaces (or a single re-configurable interface) for accessing both of the networks 11, 12, although the Home Network of the MMT 13 (i.e. that network responsible for AAA, roaming etc.) is the cellular network 11. The cellular network 11 provides access for the MMT 13 to packet-switched services over a wireless link via a UMTS radio access network (not shown) comprising a series of base stations (or Node Bs) 14. A dashed line shows the area of coverage provided by each base station 14. Depending on the service used by the user, packet data may be routed from the cellular network 11 to the Internet 16 or to another public land mobile network (PLMN), not shown. The packet-switched domain of the cellular network 11 provides a bi-directional link for the MMT 13 to transfer/receive packet data to/from external packet-switched networks such as the Internet 16.

A gateway router known as the Gateway GPRS Support Node (GGSN) (not shown in FIG. 1) at the edge of the cellular network 11 routes all incoming and outgoing packet data on behalf of MMTs attached to the cellular network. Thus all packets sent to the IP address assigned to an interface on the MMT 13 are routed to the GGSN, which then tunnels the packets toward the MMT 13 over various cellular network entities. When the packets reach the MMT 13 they are de-capsulated to reveal the original IP header and its data can be read by applications on the MMT 13.

MMTs 13 combined with the User Subscriber Identity Module (USIM) are referred to by the term “User Equipment” (UE) in UMTS terminology. However, throughout the present document the term “Mobile Terminal (MT)” is used generically to indicate such devices and any other wireless network access device. “Mobile Station (MS)”, a term used in the context of GSM and GPRS networks, is equivalent to the User Equipment.

The broadcast network 12 comprises a series of transmitters 15 (only one shown) each transmitter 15 having, in general, a larger area of coverage than a base station 14. A dotted line shows the area of coverage of the transmitter 15. Typically each base station 14 will provide an area of signal coverage for the MMT 13 of approximately 1 to 10 km radius, whereas the transmitter 15 will typically provide signal coverage over an area of approximately hundreds of metres up to tens of kilometres. For example a large DVB cell may have a radius of about 80 km and a small DVB cell may have a radius of about 100 m. Smaller DVB cells may be provided within larger DVB cells where signal strength from the main transmitter is poor for example.

The broadcast network 12 is highly asymmetric in data transfer (usually uni-directional), and offers a much greater bandwidth on the downlink than on the uplink from the MMT 13. The broadcast network 12 can provide a packet-switched service to the MMT 13, using IP Datacast for example. Packet data is routed to a DVB Gateway 16 in the broadcast network 12. Here an IP Encapsulator (not shown) which might be part of the DVB Gateway 17 or be a separate entity, uses Multi Protocol Encapsulation (MPE) (see EN 301 192 at www.etsi.org) to place each IP packet into a sub-network data unit which is placed in the payload of an MPEG-2 Transport Stream (TS) packet. The header of the TS packet contains inter alia the MAC address of the receiver for which the TS packet is intended and a service configuration parameter which in this case comprises a Packet Identifier (PID); the MAC address enables each receiver to filter TS packets intended specifically for it, and the PID identifies a logical channel, enabling the receiver to sort TS packets according to IP address. The MPEG Transport Stream containing the IP packets may be multiplexed into another Transport Stream, either as a separate channel or by exchanging stuffing packets in another TS for example. The TS is broadcast from a number of transmitters in the broadcast network, including from the transmitter 15 for reception by a large number of MMTs in range of the transmitter 15. Using their MAC address and/or PID, each MMT can filter the correct TS packets from the multiplex and recover the IP packets therein. For example, TS packets containing IP multicast packets use the broadcast MAC address (all Is) so that all MMTs will receive the TS packet. By applying PID filtering however, only those MMTs subscribed to the multicast group will read the TS packet; the remainder will discard it.

Communication between network nodes on the cellular network 11 and on the broadcast network 12 may be accomplished using a dedicated link 18 such as a private intranet, or by means of the Internet 16 using a Virtual Private Network (VPN) for example.

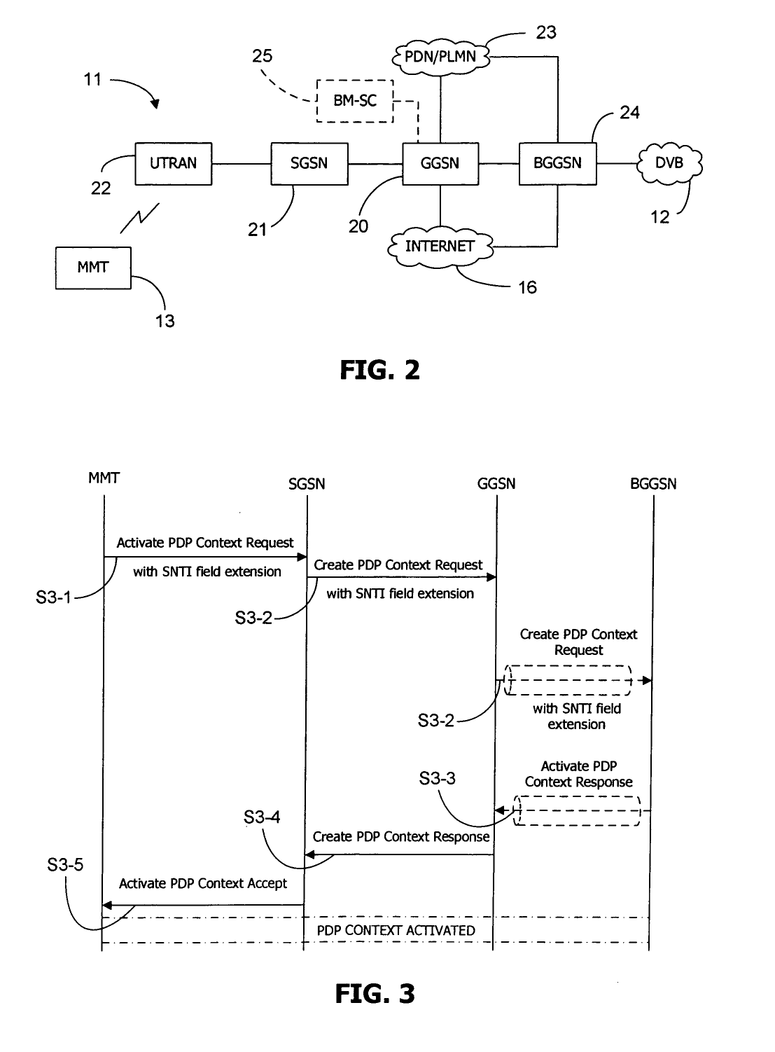

Referring to FIG. 2 the entities of the cellular network 11 (in this case a UMTS network) relevant to the invention are shown in more detail. The UMTS network has several network nodes defined at the logical level and a corresponding number of interfaces between the nodes. The packet-switched part of the UMTS network is divided into (a) the Core Network (CN) consisting of the gateway GPRS support node (GGSN) 20 and the serving GPRS support node (SGSN) 21, and (b) the UMTS Terrestrial Radio Access Network (UTRAN) 22 consisting of the radio network controller (RNC) and Node B (see base station 14 in FIG. 1). The GSNs (i.e. the GGSN and SGSN) constitute the backbone of the UMTS network 1. A brief description of the functionality of the network nodes shown in FIG. 1 relevant to the invention is given as follows:

(1) Gateway GPRS Support Node (GGSN) 3: the GGSN 3 is used as an interface to external Packet Data Networks (PDNs) 23 and the broadcast network 12. The PDN 23 may be a wide area network (WAN) for example. The GGSN 20 maintains routing information required to tunnel user data packets to the SGSN 21 serving a particular subscriber. Other functions include network and subscriber screening and address mapping.

(2) Serving GPRS Support Node (SGSN) 4: the SGSN 21 delivers packets to subscribers within its service area. The SGSN 21 detects new mobile terminals within a given service area, processes registrations of new mobile subscribers and keeps record of their location inside a given service area.

Further details of UMTS networks can be found in Third Generation Partnership Project, Technical Specification 23.060 v6.9.0, General Packet Radio Service (GPRS); Service Description; Stage 2, Release 6, June 2005 available at www.3gpp.org.

To provide packet routing through the cellular network 11 two mechanisms are of central importance: the Packet Data Protocol (PDP) and the GPRS Tunnelling Protocol (GTP). PDP is the generic name for packet data transfer during an active session (see H. Kaaranen et al. “UMTS Networks” John Wiley and Sons, 2001). Before the MMT 13 can exchange data with a host on the Internet 16 for example, the MMT 13 must first establish a logical association (or virtual connection) with the cellular network 11. This is similar to a dial-up connection established through the Public Switched Telephone Network (PSTN) in order to access a particular Internet Service Provider (ISP). In UMTS, logical connections created and maintained within the network are referred to as “PDP contexts”. The PDP context is a data structure stored in the MMT 13 and in the cellular network 11 that provides information to support packet delivery between the MMT 13 and the cellular network 11 and contains all parameters describing the packet data connection by means of end-point addresses and QoS. The PDP contexts are activated and stored in the MMT 13, SGSN 22 and GGSN 21. A single MMT 13 may have several PDP contexts (e.g. primary and secondary) associated with it. The information contained within the PDP contexts is dynamic and changes as a result of user mobility.

The GGSN 21 maintains activated PDP contexts consisting of routing information that allows the GGSN 21 to forward downlink user data packets to the serving SGSN 22. The SGSN 22 maintains activated PDP contexts consisting of routing information that enables the SGSN 22 to forward user data packets either to the GGSN 21 in the uplink direction or to the serving RNC in the downlink direction. Part of the routing information at the GGSN 21 is a mapping between IP addresses assigned to MMTs in its domain to PDP contexts. Thus when an IP packet addressed to the MMT 13 is received on an interface of the GGSN 21, it firstly looks up the PDP context corresponding to that IP address. Having done that the IP packet is then tunnelled over the cellular network 11 to the MMT 13 using GTP.

The PDP contexts maintained in the GGSN 21, SGSN 22 and MMT 13 list different items of information relevant to routing user data packets through the cellular network 11. The following is a partial list of this information:

(a) PDP context identifier (used for indexing the list of stored PDP contexts);

(b) PDP type (either X.25, PPP or IP);

(c) PDP address (e.g. an IPv4 or an IPv6 address);

(d) Access Point Name (APN), which is a logical name for an external network and/or service that the subscriber wishes to connect to; and

(e) QoS information, such as the subscribed, requested and negotiated QoS profiles.

The user of the MMT 13 terminal may desire to receive a service/content requiring a bandwidth that for whatever reason the cellular network 11 does not wish to handle or cannot provide; such a service might be Multimedia on Demand (e.g. music, video, gaming). To that end the user uses the MMT 13 to join a multicast group by sending a IGMP Membership Report message to the Multicast Management entity (not shown) in the cellular network 11. Due to its large bandwidth capacity, the broadcast network 12 would be able to handle delivery of that service for a large number of users. Accordingly it is has been proposed that the cellular network 11 may shift delivery of the service to the broadcast network 12.

There are two general cases to consider when transmitting datagrams over the broadcast network 12: multicast/broadcast and unicast.

(a) Multicast/Broadcast: an interface on the MMT 13 must be configured to filter the correct MPEG TS packets from the TS multiplex. Thus the MMT 13 must know which PID the broadcast network 12 has assigned to the multicast IP address of the service that the MMT 13 wishes to receive; furthermore, the MMT 13 will probably need to know other network configuration data such as Network ID, symbol rate and frequency. The broadcast network 12 must reserve resources and assign PID(s) for each multicast address. No MAC address data is needed, however, as MPEG TS packets are addressed to the broadcast MAC address (all 1 s) and thus will be received by all MMTs.

(b) Unicast: the MMT 13 must configure an interface with all of the data under (a) and in particular know which PID has been assigned to the unicast IP address. Furthermore the broadcast network 12 must map the MAC address of the broadcast interface to the IP address assigned to the MMT 13 so that it can address MPEG TS packets to the correct MAC address i.e. to be filtered and received by the MMT 13 only. Usually a user must advise the MAC address of the broadcast interface as part of a registration process with the broadcast provider; if the user changes the broadcast interface then he must advise the broadcast provider of the new MAC address. When an IP packet arrives at the DVB Gateway the IP address in the Destination field is mapped to the MAC address and the assigned PID, after which it is placed in an MPEG TS packet addressed to the MAC address of the MMT interface and transmitted from the broadcast network.

In either case the user is required to configure the MMT 13 to receive the correct TS from the broadcast network 12. Requiring users to do this manually may lead to incorrectly configured interfaces and dissatisfied users who might have paid for a live service for example, and then not received it. Furthermore, this requires users to be technically aware; many, of course, are not. The problem is compounded in the unicast scenario by the fact that each time the MMT establishes a PDP context it may be assigned a different IP address by the GGSN either in a stateful, e.g. DHCP, or stateless way, e.g. by assigning a 64-bit identifier to a primary PDP context and advertising a single /64 prefix to the MMT 13; the MMT 13 combines the prefix and identifier to form an IPv6 address. Thus each time the MMT 13 performs the PDP context activation procedure it will receive a different 64-bit identifier and therefore have a different IPv6 address. Accordingly the IP-MAC address mapping that the broadcast network 12 stores must be refreshed at the start of each new session (e.g. web browsing).

To solve the IP-MAC address mapping problem broadcast providers require users to provide their MAC address when first registering. Then, users are required to log on to a domain in the broadcast network 12 every time they start a new session with a packet-switched network. The broadcast network 12 then captures the current IP address assigned to the user and maps it to the MAC address using the username provided at login. The user is also required to ensure that the interface (e.g. satellite card) is configured for the correct PIDs listed on the website of the broadcast provider. This is a laborious process and requires a visit to the broadcast provider's website every time the user wishes to start a web-browsing session.

The applicant has devised a way to solve this problem more elegantly by extending the PDP context to carry additional data (as well as the existing data), and by extending the logical connection provided by the PDP context beyond the UMTS network such that the cellular network 11 and the broadcast network 12 may inter-work with one another. Referring again to FIG. 2 a new logical entity herein referred to as a Broadcast GPRS Support Node (BGGSN) 24 is part of the domain of the broadcast network 12. The BGGSN 24 may be part of a DVB Gateway for example, or might be a separate server accessible by the DVB Gateway. The BGGSN 24 provides analogous functionality to the GGSN 20 as described above with data relating to the MMT 13. All existing PDP Context fields may be of use to the broadcast network 12 e.g. QoS data, user ID, PDP Context Identifier, PDP type, PDP address. However, in addition to this the functionality of the GGSN 20 is extended as described below. The new fields that may be needed to perform this new functionality are:
(1) Downlink and uplink APN;
(2) MAC address of broadcast interface;
(3) Network/Cell ID of broadcast network or other network (e.g. WLAN) that MMT 13 has access to; and
(4) Optional authentication parameters.

A Network ID is assigned to each network operator. For example, cellular network operators have a unique System ID (SID) assigned to them by a government. In the UK the cellular network operator Vodafone® has the SID 234 15. The network operator Orange® has the SID 234 33. Further details of network operators all over the world are presently available at http://www.gsmworld.com/roaming/gsminfo/index.shtml. A WLAN has a Network ID called a Service Set Identifier (SSID) that is a 32 character unique identifier that differentiates one WLAN from another. A DVB network operator has an Original Network ID (ONETID) that serve as unique identification codes for DVB networks. Each DVB network transmits a Network Information Table (NIT) that carries dynamically updated network and transponder specific information (network name ID, frequencies, code rates etc.) for all transponders of the network. A NIT is transmitted every 10 s or less. For example a NIT transmitted from the transmitter at Crystal Palace, UK comprises the following:

| | |
|---|---|
| table_id | 0x40 |
| section_syntax_indicator | 1 |
| section length | 0x028a |
| id | 0x3005 |
| version number | 0x06 |
| current_next | 0x01 |
| section number | 0x00 |
| last section number | 0x00 |
| Name descriptor: | |
| Crystal Palace | |

Transport Stream
TS ID 0×1004
Original Network ID 0×233a

Service List Descriptor:
Service ID 0×1044→Service Type 0×1 (DIGITAL_TV_SERVICE)
Service ID 0×1084→Service Type 0×1 (DIGITAL_TV_SERVICE)
Service ID 0×10ff→Service Type 0×1 (DIGITAL_TV_SERVICE)
Service ID 0×113f→Service Type 0×1 (DIGITAL_TV_SERVICE)
Service ID 0×117f→Service Type 0×1 (DIGITAL_TV_SERVICE)
Service ID 0×123f→Service Type 0×1 (DIGITAL_TV_SERVICE)

Terrestrial Delivery System Descriptor:

| | |
|---|---|
| Frequency | 50583333 |
| Bandwidth | BANDWIDTH_8_MHZ |
| Constellation | QAM_16 |
| Hierarchy | HIERARCHY_NONE |
| Code rate HP | FEC_2_3 |
| Code rate LP | FEC_2_3 |
| Guard interval | GUARD_INTERVAL_1_32 |
| Transmission | TRANSMISSION_MODE_2K |
| Other freq. | yes |

Frequency List Descriptor:
Coding: TERRESTRIAL
Frequency: 69783333
Frequency: 69016667
Frequency: 55400000

Whatever the particular form of the Network ID it is usually broadcast by each network operator and is received and stored by the MMT 13.

As mentioned above the MMT 13 should discover the various available networks by performing a full scan to discover all available broadcast networks using any access technology. For example this may be done by scanning for the carriers e.g. for DAB, DMB and DVB-H the carriers are OFDM carriers; alternatively it might be by scanning codes in a Code Division Modulation access technology. The MMT 13 should scan for all access technologies to ensure all available networks are discovered. In order to discover the ONETID the MMT 13 needs to read the NIT for each network. This might introduce unacceptable delay into the procedure. An alternative way to discover the networks available to the MMT 13 is for the cellular network 11 to use location based services to identify the location (e.g. cell ID or location area) of the MMT 13 in the cellular network 11 and then identify the other network(s) covering the same cell ID. This might be by means of a manually configured database comprising mappings between cell ID/location and available networks. In this way the MMT does not have to perform a scan and need not read any NIT tables for example.

Referring to FIG. 3 a signalling diagram generally identified by reference numeral 30 shows establishment of a PDP context between the MMT 13, the SGSN 21, the GGSN 20 and the BGGSN 24. This signalling is necessary before the MMT 13 is able to request a service (e.g. delivery of content from a remote content provider) over the cellular network 11 and to receive that service through the broadcast network 12. Having obtained the necessary radio resources the MMT 13 uses at step S3-1 the conventional Activate PDP Context Request procedure described for example in 3GPP TS 23.060 V6.9.0 to which reference is specifically made in this respect. However, as mentioned above the fields of the PDP context are extended beyond the standard fields. In particular, amongst the other fields transmitted (such as NSAPI, TI, PDP Type, PDP Address, Access Point Name (APN), QoS Requested etc.) the PDP context comprises a new field herein referred to as a Secondary Network Terminal Identifier (SNTI): this field comprises the MAC address of the broadcast interface of the MMT 13, a broadcast (i.e. downlink) APN and a cellular (i.e. uplink) APN of the broadcast network 12. The MMT 13 obtains the MAC address by querying the broadcast interface. The downlink/uplink APN is a reference to the GGSN to be used to provide the requested service, and may also identify the PDN and the service requested. In the present case the cellular or uplink APN is used to indicate an inter-working of networks service and therefore references a GGSN in the cellular network 11 capable of providing that inter-working. Likewise the broadcast or downlink APN is used to reference the BGGSN 24 i.e. that entity in the broadcast network 12 that will be responsible for the inter-working from the broadcast network's perspective. The MMT 13 is pre-configured with APNs representing the different services that it can access. Accordingly the downlink and uplink APNs are simply obtained from a memory on the MMT 13.

The SGSN 21 receives the Activate PDP Context Request and validates it according to usual procedure. Assuming the request is valid the SGSN 21 resolves the cellular or uplink APN using a DNS (or APN resolution). The DNS returns the IP address of one or more GGSN 20 that will provide the required uplink connectivity. The SGSN 21 creates a TEID (Tunnel Endpoint Identifier) to establish a GTP tunnel and at step S3-2 sends a Create PDP Context Request to the GGSN 20.

The GGSN 20 receives the request and completes establishment of the GTP tunnel to enable exchange of packet data units between the SGSN 21 and GGSN 20 for that PDP context. The inclusion of a broadcast or downlink APN enables the GGSN 20 to lookup in a DNS (or APN resolution) the IP address of the BGGSN 24 on the broadcast network 12 that will provide the required downlink connectivity. Alternatively the GGSN 20 may use location data comprising the Network ID and/or Cell ID to find the IP address of the BGGSN 24. This may be performed using a Network Domain Server (NDS) that comprises mappings between location data (i.e. Network ID/Cell ID) and a communication address e.g. Gateway IP address (e.g. of the BGGSN 24). The NDS/DNS may be configured manually upon conclusion of SLAs (Service Level Agreements) for example between the respective network operator of the broadcast and cellular networks. Finally the GGSN 21 creates an entry in its PDP context table that stores inter alia a mapping between a PDP address, the IP address assigned by the GGSN 20 to the MMT 13, and the IP address of the BGGSN 24 on the broadcast network 12 (as returned by the DNS server).

The GGSN 20 is now in a position to extend the logical connection outside the cellular network 11 by sending a Create PDP Context Request message to the BGGSN 24 at step S3-3. This message is similar to the Create PDP Context Request message described above sent by the SGSN 21 to the GGSN 20. In particular it contains the SNTI field, and the IP address assigned to the MMT 13 by the GGSN 20. Alternatively all of the usual PDP Context data may be sent as part of the Create PDP Context Request message; this may be useful if the broadcast network 12 requires information about QoS, authentication, etc. The Create PDP Context Request sent by the GGSN 20 is tunnelled to the BGGSN 20 e.g. by encapsulating the message in IP packets and transmitting over the Internet 16. Referring again to FIG. 2 the BGGSN 24 can be contacted in various ways: for example via a VPN, a private intranet using the PDN 23, or via a direct connection.

Receipt by the BGGSN 24 of the Create PDP Context Request from the GGSN 20 triggers the BGGSN 24 to reserve the necessary radio resources and to determine the necessary configuration data for the MMT 13 to receive data from the broadcast network 12. For example in the multicast case (scenario (a) above) the BGGSN will lookup the PID that has been assigned for the multicast service. In the unicast case (scenario (b) above) the BGGSN will assign a PID for the MMT 13. Furthermore in the unicast case the BGGSN will read the SNTI field and the PDP address field of the PDP context information element (i.e. the IP address assigned to the MMT 13) and map the two together to provide the IP-MAC mapping referred to above. The IP-MAC mapping is stored in the broadcast network 12. Other network configuration data (e.g. frequency, symbol rate, Network ID, etc.) are then determined for the MMT 13 based on the type of service requested. Finally the BGGSN 24 creates a new entry in its PDP context table similar to that stored by the GGSN 20. No user input is required to obtain the IP-MAC mapping.

The BGGSN 24 is now ready confirm allocation of resources for the MMT 13 and to advise the configuration parameters needed to receive data from the broadcast network 12. The aforementioned configuration parameters are entered into an extended Create PDP Context Response message. The message comprises the conventional fields and is extended with fields containing the configuration parameters that the MMT 13 will need to configure its broadcast interface to receive the requested service. The configuration parameters can be one of two types: network interface configuration and service configuration parameters. The interface configuration parameters may include frequency, symbol rate and polarization. The service configuration parameters may include the PID, the multicast IP address and port number, and the broadcast service information. The broadcast service information includes the Program Specific Information (PSI) and Service Information (SI) tables with information specific only to the service the MTT 13 has requested.

The BGGSN 24 also indicates in the message that a PDP context has been created. The extended Create PDP Context Response message is tunnelled to the GGSN 20 using the Internet 16 at step S3-3, or by using any other suitable method as mentioned above.

When the GGSN 20 receives the extended Create PDP Context Response message it activates the PDP context and may start forwarding to the BGGSN 24 IP packets that it receives which are addressed to the MMT 13, and will also forward to the Internet any T-PDUs that it receives from the SGSN 21 relating to the service. The GGSN 20 also forwards a similar extended Create PDP Context Response to the SGSN 21 at step S3-4 which comprises the conventional fields (see 3GPP specification referred to above) extended with the additional fields also mentioned above. Upon receipt the SGSN 21 activates the PDP context and may start to forward T-PDUs from the MMT 13 to the GGSN 20. The SGSN 21 also forwards an extended Activate PDP Context Accept message at step S3-5. This message contains the configuration data needed by the MMT 13 to configure its broadcast interface to receive over the broadcast network 12 the service that has been requested.

When the MMT 13 receives the extended Activate PDP Context Accept message it reads the data contained in the extension. The fields are extracted and automatically inserted into corresponding data fields of a configuration application that configures the broadcast interface of the MMT 13. A logical association (or connection) 31 now exists between the MMT 13, SGSN 21, GGSN 20 and BGGSN 24 i.e. between the MMT 13 and the BGGSN 24 via the cellular network 11.

In this way a logical or virtual connection has been established between entities on the cellular network 11 and the broadcast network 12 in response to a request for service and/or delivery of content by the MMT 13. Furthermore, having established the logical connection 31 the broadcast network 12 is able to advise the necessary network configuration data without the need to rely on broadcast of IP/MAC Notification Tables (INTs) or the like. Accordingly the MMT 13 is released from INT processing thereby saving battery power, a high priority for handheld devices. The broadcast interface of the MMT 13 can then be configured automatically without any input from the user being required. Accordingly any updates, such as a change in MAC address of the broadcast interface or a change in IP assigned by the cellular network 11, can be performed without user intervention or action. Furthermore if content is to be delivered by unicast, any change in the IP address assigned to the MMT 13 (e.g. if a secondary PDP context is set up or if the primary PDP context is re-established) can be signalled to the BGGSN 24 automatically using the SNTI field.

By using the cellular network 11 as the access service provider through the extended PDP context activation, the broadcast network 12 may not be required to authenticate the user of the MMT 13, and need only be aware of those users that actually require a broadcast downlink. This helps to reduce the load on the broadcast network 12. If additional authentication is required then the broadcast network 12 may use the optional authentication parameters contained in the Create PDP Context Request message.

The invention may also be applied in an Multimedia Broadcast Multicast Service (MBMS) architecture. This architecture is described in detail in ETSI TS 123 246 V6.7.0 to which reference is specifically made in this respect. In general terms MBMS is point to multipoint service in which data is transmitted from a single source to multiple recipients over a cellular network. There are two modes: multicast and broadcast. A functional entity known as the Broadcast Multicast Service Centre (BM-SC) provides functions for MBMS user services and delivery, and may serve as an entry point or gateway for content provider MBMS transmissions. The BM-SC 25 is the extra entity that is required over the architecture illustrated in FIG. 2 in order to make the cellular network MBMS capable (although extra functionality is required at the other network nodes). Referring to FIG. 2 a BM-SC 25 is shown having an interface with the GGSN 20. The BM-SC 25 has one or more interface for receiving content from external content providers (not shown). The MBMS specification also proposes creation of a data structure known as a MBMS UE Context whose function is similar to a PDP Context. The MBMS UE Context comprises the same data as a PDP Context but also has additional data needed to support multicast/broadcast services on the cellular network (e.g. UMTS).

Via the BM-SC 25 light video and audio clips, and possibly real-time streaming, can be offered over a cellular network. However, for heavy duty streaming in a wide area for a large concentrated audience there are more suitable solutions such as DVB-H. Accordingly, whilst some multicast/broadcast services may be delivered using a cellular network, it may be more efficient to deliver more data intensive services using a digital broadcast network such as DVB. As explained elsewhere herein, it is thus important that the MBMS-capable cellular network is able inter-work with a broadcast network to this end.

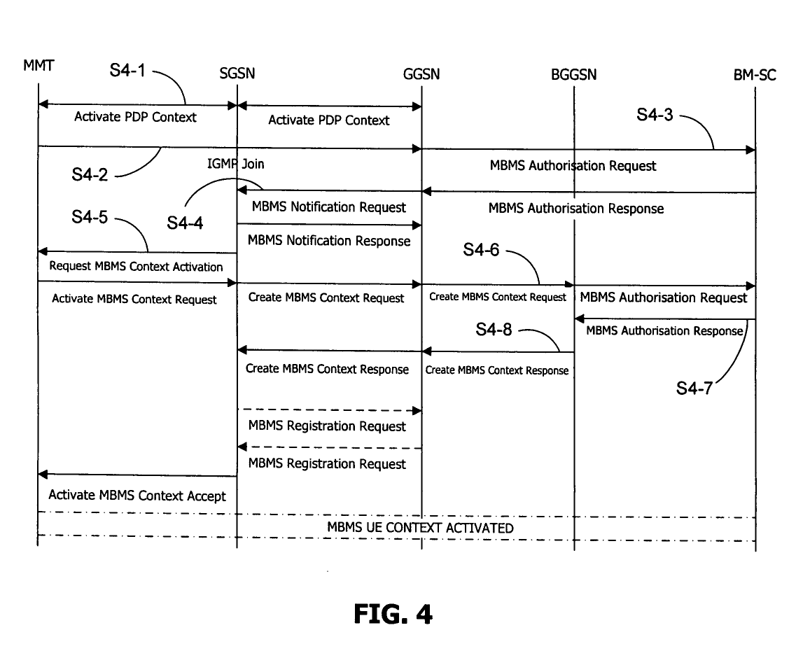

Referring to FIG. 4 a signalling diagram generally identified by reference numeral 50 illustrates how the MBMS UE Context may be extended to include the broadcast network 12. This facilitates delivery of multicast/broadcast datagrams via the broadcast network 12 instead of via the cellular network 11. At step S4-1 the MMT 13 establishes a PDP Context in the usual way. At step S4-2 the MMT 13 sends an IGMP Join (IPv4) or Multicast Listener Discovery (MLD) (IPv6) message using the PDP Context; this signals to the GGSN 20 that the user is interested in receiving a particular multicast service. The GGSN 20 sends an MBMS Authorisation Request to the BM-SC 25 at step S4-3 to determine whether or not the MMT 13 is permitted to receive that service. The BM-SC 25 responds with an MBMS Authorisation Response that contains the APN to be used for the creation of the MBMS UE Context; this APN may or may not resolve to the GGSN 20. For example, if the BM-SC 25 determines that the service should be delivered by another network such as the broadcast network 12, the APN corresponds to the BGGSN 24. However, if the MMT 13 is able to choose which network it would like to deliver the service the BM-SC 25 returns APN(s) of the or each available network. The GGSN 20 sends at step S4-4 a MBMS Notification Request to the SGSN 21 and it responds with an MBMS Notification Response. The SGSN sends a Request MBMS Context Activation message to the MMT 13 at step S4-5 causing the MMT 13 to create an extended MBMS UE Context.

The MMT 13 sends an extended Activate MBMS Context Request back to the SGSN 21. The message comprises the following fields: IP multicast address, APN, MBMS_NSAPI, MBMS bearer capabilities, extended with the following fields: downlink APN, Network ID(s), Cell ID(s), broadcast interface MAC address, and extra authentication parameters. The MMT 13 should leave the downlink APN field blank if it wishes the GGSN 20 to determine the network that will deliver the service/content.

The GGSN 20 receives the request and, assuming the downlink APN field is blank, determines which network will serve the user. This should be decided based on the Network ID and/or Cell ID that the MMT 13 has included in the message or may be based on a location are of the MMT 13 stored and kept current on the cellular network 11. The GGSN 20 uses this data to perform a NDS/DNS lookup as described above to obtain IP addresses of appropriate entities (e.g. BGGSN 24) on the other networks. The GGSN 20 may select one of these networks to deliver the service based on SLAs for example. If the user has specified a downlink APN, the GGSN looks up the IP address of the entity with which it should correspond to this end. At step S4-6 the GGSN 20 then forwards the Activate MBMS Context Request on to the BGGSN 24 (or whichever entity is assigned to the same task in another network). The GGSN also includes the original IGMP of MLD Join message so that the BGGSN 24 can take the appropriate action to receive multicast packets of the service.

Receipt by the BGGSN 24 of the Create MBMS PDP Context Request from the GGSN 20 triggers the BGGSN 24 to reserve the necessary radio resources and to determine the necessary configuration data for the MMT 13 to receive datagrams from the broadcast network 12. The BGGSN 24 then uses standard procedures for sending an MBMS Authorisation Request to the BM-SC 25. This is followed by standard Authorisation Response from the BM-SC 25 at step S4-7.

The BGGSN 23 is now ready to confirm allocation of resources for the MMT 13 and to advise the configuration parameters needed to receive data from the broadcast network 12. The aforementioned configuration data is entered into an extended Create MBMS Context Response message which is sent to the GGSN 20 at step S4-8. The message is extended with fields containing the configuration parameters that the MMT 13 will need to configure its broadcast interface to receive the requested service. The configuration parameters comprise network interface configuration and service configuration parameters. The interface configuration parameters might include frequency, symbol rate and polarization. The service configuration parameters might include the PID, multicast IP address and port number, and broadcast network service information including the PSI and SI tables with information specific only to the service the MTT 13 has requested.

The configuration parameters are then forwarded back to the MMT 13 by the messaging procedures described in the reference mentioned above and a MBMS UE Context is established by storage of the data structure in each of the MMT 13, SGSN 21, GGSN 20, BGGSN 24 and BM-SC 25. This data structure provides a logical association or virtual connection for that MMT 13 in the aforementioned entities that enables the cellular network 11 to inter-work with the broadcast network 12 such that a multicast-broadcast service requested via the cellular network 11 may be delivered by the broadcast network 12.

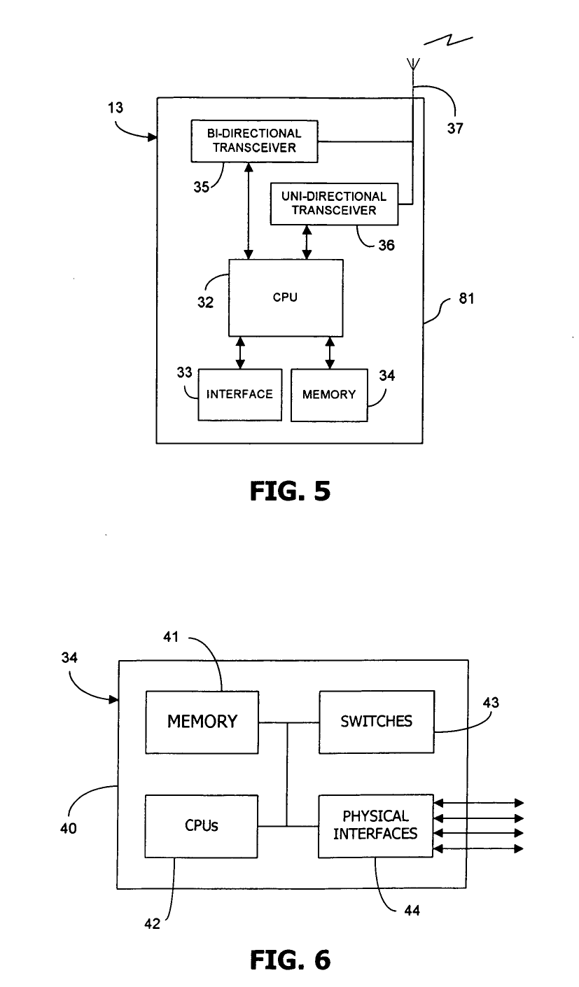

Referring to FIG. 5 the MMT 13 comprises a case 31 housing a CPU 32, an interface 33, a memory 34, a bi-directional transceiver BT (or interface) 35 and a uni-directional transceiver UT (or interface) 36. The BT 35 and the UT 36 are wired to an antenna 37 for reception and transmission of data with the cellular network 11 and for reception of data from the broadcast network 12 respectively. The CPU 32 interfaces with all of the aforementioned components to process (store, access, etc.) electronic data. The memory 34 stores computer executable instructions that when executed by the CPU 32 perform the MMT method steps described above. The computer executable instructions might be placed on the MMT 13 at point of manufacture; alternatively, they may be provided in the form of an upgrade from the Home Network.

Referring to FIG. 6 the GGSN 20 comprises a case 40 housing an electronic memory 41 (e.g. hard disk, RAM), one or more CPU 42, one or more switch 43, and one or more physical interface 44. All of these components are in electronic communication with one another. Each physical interface 44 is connected to a network such as an external PDN (e.g. the Internet), a WAN or LAN. One of the physical interfaces provides a connection for transfer of data to an interface on the cellular network 11 described above. The memory 41 stores a routing table to assist routing of datagrams arriving on the physical interfaces 44, and also stores computer executable instructions for performing the GGSN steps described above.

A generally similar block diagram to FIG. 6 may describe the SGSN 21, BGGSN 24 or BM-SC 25 respectively, with the memory storing computer executable instructions for performing the corresponding method steps described above.

The invention is useable in any kind of uni-directional broadcast network, for example protocols and standards conceived and administered by the American Television Standards Committee (ATSC), European Telecommunications Standards Institute Digital Video Broadcasting (DVB), Korean Digital Multimedia Broadcasting (DMB) and Japanese Integrated Service Digital Broadcasting (ISDB). It is envisaged that the invention may be utilised to transmit datagrams (e.g. IP datacast) using any such digital broadcast network using any wireless transmission technology, such as satellite (e.g. DVB-S) and terrestrial based transmitters (e.g. DVB-T, ISDB-T and DVB-H) for example.

The use of the invention in bi-directional networks is not limited to the cellular network described herein. Any current or future cellular network may be configured to operate in accordance with the invention. Current cellular networks include GSM, GPRS, EDGE, UMTS or any other network implemented according to IMT-2000; Personal Digital Cellular (PDC); CDMA IS-95 e.g. CDMAone and CDMA2000.

The MMT 13 may be any mobile terminal that can that can be carried by hand, including Personal Digital Assistants (PDAs), notebook computers, mobile/smart telephones, gaming apparatus and digital music players. The mobile terminal may have two or more physical interfaces or a single reconfigurable interface (using e.g. software defined radio) to access the different networks in the heterogeneous environment. In one aspect the MMT is a terminal capable of receiving mobile broadcast services and bi-directional services. The services that might be suitable for delivery over a mobile broadcast channel are wide-ranging but include peer-to-peer file sharing, television broadcasts, online gaming, simultaneous transmission of files to many receivers such as online newspapers, games, digital video and music files, and computer software.

Although the embodiments of the invention described with reference to the drawings comprises computer apparatus and methods performed in computer apparatus, the invention also extends to computer programs, particularly computer programs on or in a carrier, adapted for putting the invention into practice. The program may be in the form of source code, object code, a code intermediate source and object code such as in partially compiled form, or in any other form suitable for use in the implementation of the methods according to the invention. The carrier may be any entity or device capable of carrying the program.

For example, the carrier may comprise a storage medium, such as a ROM, for example a CD ROM or a semiconductor ROM, or a magnetic recording medium, for example a floppy disc or hard disk. Further, the carrier may be a transmissible carrier such as an electrical or optical signal that may be conveyed via electrical or optical cable or by radio or other means.

When the program is embodied in a signal that may be conveyed directly by a cable or other device or means, the carrier may be constituted by such cable or other device or means. Alternatively, the carrier may be an integrated circuit in which the program is embedded, the integrated circuit being adapted for performing, or for use in the performance of, the relevant methods.

What is claimed is:

1. A method of providing access for a multi-mode mobile terminal to packet-switched services in a heterogeneous network environment comprising a uni-directional network and a bi-directional network, which method comprises the step of creating and storing a data structure in each of said multi-mode mobile terminal, said bi-directional network and said uni-directional network, storing of said data structures activating a logical association between said multi-mode mobile terminal and said unidirectional network via said bi-directional network, which logical association facilitates inter-working of said uni-directional and bi-directional networks for delivering datagrams to said multi-mode mobile terminal from said uni-directional network.

2. A method according to claim 1, further comprising the step of using said data structure to facilitate routing of datagrams between said bi-directional network and said uni-directional network.

3. A method according to claim 1, further comprising the step of using said logical association to transfer a configuration parameter from said uni-directional network to said multi-mode mobile terminal via said bi-directional network.

4. A method according to claim 3, wherein said configuration parameter comprises a service configuration parameter mapping link layer packets to be transmitted by said uni-directional network, to a network layer address to which a service is addressed, receipt of said service configuration parameter enabling said multi-mode mobile terminal to extract and read the link layer packets comprising said service.

5. A method according to claim 4, wherein said service configuration parameter comprises a Packet Identifier (PID) and said link layer packets comprise MPEG Transport Stream Packets.

6. A method according to claim 3, wherein said configuration data comprises a network interface configuration parameter for configuring an interface of said multi-mode terminal to receive datagrams from said uni-directional network.

7. A method according to claim 3, further comprising the step of said multi-mode mobile terminal receiving said configuration data and configuring an interface therewith.

8. A method according to claim 7, wherein said configuring step is performed automatically by said multi-mode mobile terminal when said configuration parameter is received.

9. A method according to claim 1, further comprising the step of said multi-mode mobile terminal requesting a one-to-many type service, wherein said logical association is established in response to said request.

10. A method according to claim 9, wherein said one-to-many type service is to be delivered by one of a multicast and a broadcast transmission protocol.

11. A method according to claim 1, further comprising the step of said multi-mode mobile terminal transmitting toward said uni-directional network a link-layer address by which it is reachable, receipt of said link-layer address enabling said uni-directional network to map a network layer address of said multi-mode mobile terminal to said link-layer address, whereby datagrams arriving at said uni-directional network addressed to said network layer address may be encapsulated in link-layer packets addressed to said link-layer address by means of said mapping.

12. A method according to claim 11, further comprising the step of said bi-directional network receiving said link-layer address and storing it as part of said data structure.

13. A method according claim 12, further comprising the step of said bi-directional network forwarding said link-layer address toward said uni-directional network.

14. A method according to claim 13, further comprising the step of configuring a network layer address for said multi-mode mobile terminal, and forwarding said network layer address toward said uni-directional network.

15. A method according to claim 14, wherein said network layer address is transmitted with said link-layer address to facilitate said mapping.

16. A method according to claim 14, further comprising the step of said uni-directional network receiving said link-layer address and storing as part of said data structure.

17. A method according to claim 14, further comprising the step of mapping said link-layer address to said network layer address and storing as part of said data structure in said uni-directional network.

18. A method according to claim 14, storing of said data structure triggering said uni-directional network to transmit a configuration parameter toward said multi-mode mobile via said bi-directional network, said configuration parameter for facilitating configuration of said multi-mode mobile terminal to receive data from said uni-directional network.

19. A method according to claim 11, further comprising the step of said multi-mode mobile terminal requesting a one-to-one type service, wherein said logical association is established in response to said request.

20. A method according to claim 19, wherein said one-to-one type service is to be delivered by a unicast transmission protocol.

21. A method according to claim 1, further comprising the steps of said multi-mode mobile terminal transmitting a uni-directional Access Point Name (APN) toward said bi-directional network, said bi-directional network using said uni-directional APN to lookup an address representing a network node on said uni-directional network with which said logical association is to be established.

22. A method according to claim 1, further comprising the steps of using location data representing a current or recent physical location of said multi-mode mobile terminal to query a network domain database comprising a mapping between location data and communication addresses, said network domain database returning a list comprising a communication address for the or each available data communication network, each of which provides coverage at said physical location, whereby said bi-directional network may contact the or each available data communication network.

23. A method according to claim 22, further comprising the steps of listening to determine a network identity of each data communication network having a downlink channel that can be received by said multi-mode mobile terminal, and transmitting said location data comprising the or each network identity to said bi-directional data communication network.

24. A method according to claim 22, further comprising the step of for each available data communication network determining a cell identity of a cell in which said multi-mode terminal presently resides, and transmitting said location data comprising the or each cell identity to said second data communication network.

25. A method according to claim 1, wherein said data structure comprises a field storing a link-layer address of said multi-mode mobile terminal.

26. A method according to claim 1, wherein said data structure comprises an extended PDP context, the method further comprising the step of said multi-mode mobile terminal sending an activate PDP context request comprising an extended PDP information element comprising a link-layer address of a uni-directional interface of said multi-mode terminal.

27. A method according to claim 26, a network node on said bi-directional network further performing the steps of receiving said activate PDP context request, storing said an extended PDP context on said network node, and sending a create PDP context request to said uni-directional network, said create PDP context request comprising said extended PDP information element.

28. A method according to claim 24, a network node on said uni-directional network further performing the steps of receiving said create PDP context request, storing said an extended PDP context on said network node, and sending an activate PDP context response to said bi-directional network, said activate PDP context response comprising a service configuration parameter and a network interface configuration parameter.

29. A method of configuring a multi-mode mobile terminal for receiving packet-switched services at from a uni-directional network, which method comprises the steps of:
(a) sending from said multi-mode mobile terminal to a bi-directional network a request for access to a packet-switched data service;
(b) awaiting from said bi-directional network a service configuration parameter and a network interface configuration parameter for said uni-directional network;
(c) using said network interface configuration parameter to configure an interface on said multi-mode mobile terminal to receive data from said uni-directional network; and
(d) using said service configuration parameter to filter a channel comprising said packet-switched service from data transmitted from said uni-directional network.

30. A method of establishing a logical association between a bi-directional network and a uni-directional network, which method comprises the steps of:
(a) receiving on said bi-directional network a request from a multi-mode mobile terminal for access to a packet-switched data service;
(b) storing a data structure in a memory of a network node on said bi-directional network;
(c) and transmitting a request to a network node on said uni-directional network as part of establishment of said logical association.

31. A method of establishing a logical association between a bi-directional network and a uni-directional network, which method comprises the steps of:
(a) receiving on said uni-directional network a request from a network node on said bi-directional network for access to a packet-switched data service;
(b) storing a data structure in a memory of a network node on said uni-directional network; and
(c) transmitting a reply to the network node on said bi-directional network as part of establishment of said logical association.

32. A multi-mode mobile terminal for use in a method of providing access for a multi-mode mobile terminal to packet-switched services in a heterogeneous network environment comprising a unidirectional network and a bi-directional network,
said multi-mode terminal comprising a memory storing computer executable instructions for performing the steps of creating and storing a data structure in said multi-mode mobile terminal, storing of said data structure activating a logical association between said multi-mode mobile terminal and said uni-directional network via said bi-directional network, which logical association facilitates inter-working of said uni-directional and bi-directional networks for delivering datagrams to said multi-mode mobile terminal from said uni-directional network.

33. A computer program for use in a method of providing access for a multi-mode mobile terminal to packet-switched services in a heterogeneous network environment comprising a uni-directional network and a bi-directional network,
said computer program comprising computer executable instructions for creating and storing a data structure in said multi-mode mobile terminal, storing of said data structure activating a logical association between said multi-mode mobile terminal and said uni-directional network via said bi-directional network, which logical association facilitates inter-working of said uni-directional and bi-directional networks for delivering datagrams to said multi-mode mobile terminal from said uni-directional network.

34. A network node for a bi-directional network for use in a method of providing access for a multi-mode terminal to packet-switched services in a heterogeneous network environment comprising a uni-directional network and said bi-directional network,
said network node comprising a memory storing computer executable instructions for creating and storing a data structure in said bi-directional network, storing of said data structure activating a logical association between said multi-mode mobile terminal and said uni-directional network via said bi-directional network, which logical association facilitates inter-working of said uni-directional and bi-directional networks for delivering datagrams to said multi-mode mobile terminal from said uni-directional network.

35. A network node as claimed in claim 34, which network node comprises a GGSN and/or a SGSN and/or BM-SC.

36. A computer program for use in a method of providing access for a multi-mode mobile terminal to packet-switched services in a heterogeneous network environment comprising a uni-directional network and a bi-directional network,
said computer program comprising computer executable instructions for creating and storing a data structure in said bi-directional network, storing of said data structure activating a logical association between said multi-mode mobile terminal and said uni-directional network via said bi-directional network, which logical association facilitates inter-working of said uni-directional and bi-directional networks for delivering datagrams to said multi-mode mobile terminal from said uni-directional network.

37. A network node for a uni-directional network for use in a method of providing access for a multi-mode terminal to packet-switched services in a heterogeneous network environment comprising said uni-directional network and a bi-directional network,
said network node comprising a memory storing computer executable instructions for creating and storing a data structure in said uni-directional network, storing of said data structure activating a logical association between said multi-mode mobile terminal and said uni-directional network via said bi-directional network, which logical association facilitates inter-working of said uni-directional and bi-directional networks for delivering datagrams to said multi-mode mobile terminal from said uni-directional network.

38. A network node as claimed in claim 37, which network node comprises a gateway to said uni-directional network.

39. A computer program for use in a method of providing access for a multi-mode mobile terminal to packet-switched services in a heterogeneous network environment comprising a uni-directional network and a bi-directional network,
said computer program comprising computer executable instructions for creating and storing a data structure in said uni-directional network, storing of said data structure activating a logical association between said multi-mode mobile terminal and said uni-directional network via said bi-directional network, which logical association facilitates inter-working of said uni-directional and bi-directional networks for delivering datagrams to said multi-mode mobile terminal from said uni-directional network.
